(19) United States
(12) Patent Application Publication
(10) Pub. No.: US 2022/0212503 A1
(43) Pub. Date: Jul. 7, 2022

(54) HEAVY-DUTY TIRE

(71) Applicant: HANKOOK TIRE & TECHNOLOGY CO., LTD., Seongnam-si (KR)

(72) Inventors: Sung Ryul BAE, Daejeon (KR); Hee Nam KIM, Daejeon (KR); Yong Keun KIM, Daejeon (KR); Yoon Gon LEE, Sejong-si (KR)

(21) Appl. No.: 17/568,516

(22) Filed: Jan. 4, 2022

(30) Foreign Application Priority Data
Jan. 4, 2021 (KR) 10-2021-0000153

(51) Int. Cl. B60C 9/20; B60C 9/00

(52) U.S. Cl. CPC B60C 9/20; B60C 2009/209; B60C 2200/06; B60C 9/0007

(57) ABSTRACT

The present disclosure provides a heavy-duty tire including: a tread part configured to come into contact with a road surface; a steel belt part including one or more steel belts formed inside the tread part; and a reinforcing belt part inserted between the one or more steel belts or between the tread part and the steel belt part, in which the reinforcing belt part is manufactured as a rolling product made by winding a steel cord in a circumferential direction of the tire.

### CROSS REFERENCE TO RELATED APPLICATION

The present application claims priority to Korean Patent Application No. 10-2021-0000153, filed on Jan. 4, 2021, the entire contents of which is incorporated herein for all purposes by this reference.

### BACKGROUND OF THE INVENTION

### Field of the Invention

The present disclosure relates to a heavy-duty tire, and more particularly, to a heavy-duty tire to which a technology for winding a reinforcing belt part in a circumferential direction of the tire is applied.

### Description of the Related Art

In the related art, a heavy-duty tire for a truck or bus includes steel belts disposed in four layers, and a carcass disposed in a single layer. FIG. 1 illustrates the tire in the related art.

Recently, as a load per tire increases, a reinforcing belt is additionally applied to optimize a ground contact shape (a grounded shape of the tire when the tire is in contact with the ground surface) and enhance durability performance of the belts.

In general, in a case in which a reinforcing belt is applied between a second belt and a third belt, a single strand of steel cord is wound in a spiral coil shape at an angle of 0 to 1 degree.

Meanwhile, 5 to 10 minutes (at a working speed of 120 MPM (120 m/min)) are required for each tire to wind a single strand of steel cord spirally. To improve the working process of winding the steel cord spirally (in the form of an infinite coil) as described above, a dual-strand supply technology for supplying two strands of steel cords is also applied.

However, the technology for winding the single or two strands of steel cords has a limitation in improving the ground contact shape by inhibiting an overall growth of an outer portion of the belt.

That is, a method of winding several strands of steel cords in the form of a rolling product having a predetermined width is more effective in inhibiting an overall growth of the belt compared to the method of winding the single strand of steel cord.

Recently, as autonomous driving technologies are activated, it is preferable that tires, which are excellent in long-term durability and abraded uniformly by a ground contact shape optimized by an increase in load per tire, are applied to large-size vehicles such as trucks and buses in the future.

However, since the reinforcing belt in the related art is manufactured by winding the single or two strands of steel cords spirally, there is a problem in that the performance in manufacturing the reinforcing belt is deficient.

In addition, the dual-strand supply method also causes a spatial limitation because an additional facility needs to be manufactured. For this reason, the dual-strand supply method has a limitation in inhibiting the growth of a casing of the entire belt.

Therefore, to improve abrasion performance and durability performance of the tire to be applied to the large-size vehicle, there is a need to develop a technology for uniformizing and minimizing a ground pressure of a tread part in contact with the ground surface and minimizing the amount of growth of the tire in a circumferential direction of the tire when the vehicle travels over a long period of time.

(Patent Document 1) Patent No. 10-2130374 (Jun. 30, 2020)

(Patent Document 2) Patent No. 10-2172330 (Oct. 26, 2020)

### SUMMARY OF THE INVENTION

The present disclosure has been made in an effort to solve the above-mentioned problems, and an object of the present disclosure is to provide a heavy-duty tire, in which a reinforcing belt part is inserted, in a circumference direction of the tire, into at least one steel belt or between a tread part and a steel belt part, thereby improving durability, RR performance, and handling performance of the steel belt part, uniformizing a ground pressure applied to the tread part, and reducing a rate of incidence of unsuitable air pressure.

Technical problems to be solved by the present disclosure are not limited to the above-mentioned technical problems, and other technical problems, which are not mentioned above, may be clearly understood from the following descriptions by those skilled in the art to which the present disclosure pertains.

To achieve the above-mentioned object, the present disclosure provides a heavy-duty tire including: a tread part configured to come into contact with a road surface; a steel belt part including one or more steel belts formed inside the tread part; and a reinforcing belt part inserted between the one or more steel belts or between the tread part and the steel belt part, in which the reinforcing belt part is manufactured as a rolling product made by winding a steel cord in a circumferential direction of the tire.

In the embodiment of the present disclosure, the one or more steel belts may include: a first steel belt disposed adjacent to a carcass; a second steel belt positioned above the first steel belt; a third steel belt positioned above the second steel belt; and a fourth steel belt positioned above the third steel belt, and the reinforcing belt part may be wound once or twice in the circumferential direction of the tire on outermost peripheral layers of the first and third steel belts or outermost peripheral layers of the second and fourth steel belts.

In the embodiment of the present disclosure, the reinforcing belt part may be spirally formed and manufactured to have a width of 10 mm to 15 mm.

In the embodiment of the present disclosure, the one or more steel belts may include: a first steel belt disposed adjacent to a carcass; a second steel belt positioned above the first steel belt; a third steel belt positioned above the second steel belt; and a fourth steel belt positioned above the third steel belt, and the reinforcing belt part may be inserted between the second steel belt and the third steel belt and wound in the circumferential direction of the tire.

In the embodiment of the present disclosure, the reinforcing belt part may have the same width as the second steel belt.

In the embodiment of the present disclosure, the reinforcing belt parts may be respectively formed at two opposite sides and a central portion of the tread part and disposed to be spaced apart from one another.

In the embodiment of the present disclosure, the reinforcing belt part may be manufactured by rolling the steel cord within a range of 14 EPI to 18 EPI.

In the embodiment of the present disclosure, the reinforcing belt part may be manufactured to have a width of 10 mm to 20 mm.

In the embodiment of the present disclosure, the reinforcing belt part may include rubber with which the steel cord and the steel cord are topped, a diameter of the steel cord may be 0.8 mm to 1.0 mm, and a thickness of the reinforcing belt part may be 0.85 mm to 1.1 mm.

In the embodiment of the present disclosure, a tensile force of the steel cord may be 80 kgf to 110 kgf.

According to the present disclosure configured as described above, the reinforcing belt part is inserted, in the circumference direction of the tire, into at least one steel belt or between the tread part and the steel belt part, thereby improving durability, RR performance, and handling performance of the steel belt part, uniformizing the ground pressure applied to the tread part, and reducing the rate of incidence of unsuitable air pressure.

The effects of the present disclosure are not limited to the above-mentioned effects, and it should be understood that the effects of the present disclosure include all effects that may be derived from the detailed description of the present disclosure or the appended claims.

### BRIEF DESCRIPTION OF THE DRAWINGS

FIG. 1 is a cross-sectional side view illustrating a tire in the related art when viewed in one direction.

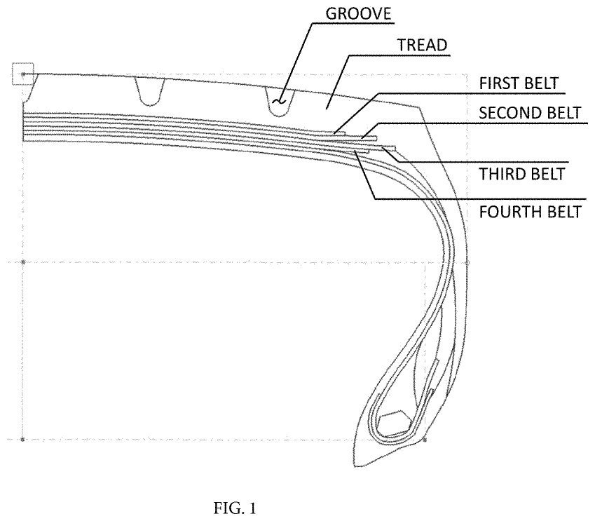

FIG. 2 is a cross-sectional side view illustrating a heavy-duty tire according to an embodiment of the present disclosure when viewed in one direction.

FIG. 3 is a view illustrating a result of analyzing the performance of the heavy-duty tire according to the embodiment of the present disclosure and the performance of a tire having a general structure.

### DETAILED DESCRIPTION OF THE INVENTION

Hereinafter, the present disclosure will be described with reference to the accompanying drawings. However, the present disclosure may be implemented in various different ways and is not limited to the embodiments described herein. A part irrelevant to the description will be omitted in the drawings in order to clearly describe the present disclosure, and similar constituent elements will be designated by similar reference numerals throughout the specification.

Throughout the present specification, when one constituent element is referred to as being “connected to (coupled to, in contact with, or linked to)” another constituent element, one constituent element can be “directly connected to” the other constituent element, and one constituent element can also be “indirectly connected to” the other element with other elements interposed therebetween. In addition, unless explicitly described to the contrary, the word “comprise/include” and variations such as “comprises/includes” or “comprising/including” will be understood to imply the inclusion of stated elements, not the exclusion of any other elements.

The terms used in the present specification are used only for the purpose of describing particular embodiments and are not intended to limit the present disclosure. Singular expressions include plural expressions unless clearly described as different meanings in the context. In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

Hereinafter, the embodiment of the present disclosure will be described with reference to the accompanying drawings.

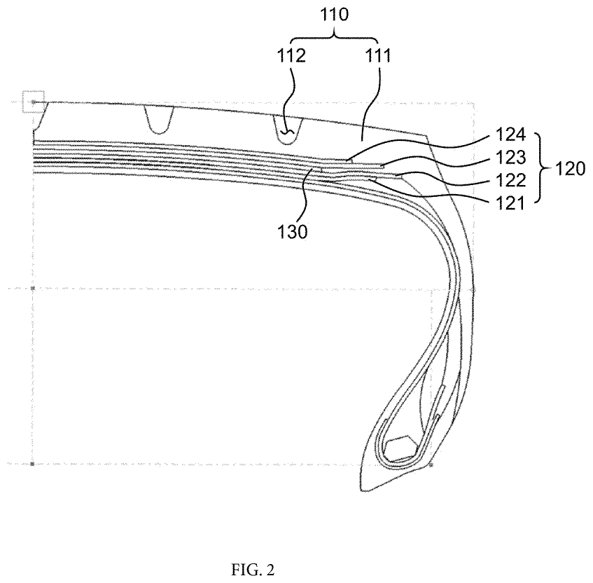

FIG. 2 is a cross-sectional side view illustrating a heavy-duty tire according to an embodiment of the present disclosure when viewed in one direction.

Referring to FIG. 2, a heavy-duty tire 100 according to an embodiment of the present disclosure includes a tread part 110, a steel belt part 120, and a reinforcing belt part 130.

When the heavy-duty tire 100 rotates while the vehicle travels, the tread part 110 comes into contact with a road surface and pushes the road surface, such that the vehicle moves. The tread part includes treads 111 and grooves 112.

The tread 111 is a portion that comes into contact with the road surface. The tread 111 may be provided in plural, and the grooves 112 are formed between the plurality of treads 111. Therefore, the plurality of treads 111 is disposed to be spaced apart from one another.

The grooves 112 are formed between the plurality of treads 111 and smoothly discharge water or foreign substances introduced while the vehicle travels in the state in which the treads 111 are in contact with the road surface.

The steel belt part 120 includes one or more steel belts 121, 122, 123, and 124 disposed inside the tread part 110. In this case, the one or more steel belts 121, 122, 123, and 124 are a first steel belt 121, a second steel belt 122, a third steel belt 123, and a fourth steel belt 124.

The first steel belt 121 is disposed adjacent to a carcass.

The second steel belt 122 is positioned above the first steel belt 121.

The third steel belt 123 is positioned above the second steel belt 122.

The fourth steel belt 124 is positioned above the third steel belt 123.

The reinforcing belt part 130 is inserted between the one or more steel belts 121, 122, 123, and 124 or between the tread part 110 and the steel belt part 120.

Specifically, the reinforcing belt part 130 is manufactured as a rolling product made by winding a steel cord in a circumferential direction of the tire.

In addition, the reinforcing belt part 130 is manufactured by rolling the steel cord within a range of 14 EPI to 18 EPI. Here, EPI represents the number of strands of steel cords per one inch.

In addition, the reinforcing belt part 130 is manufactured to have a width of 10 mm to 20 mm, and a thickness of the reinforcing belt part 130 is 0.85 mm to 1.1 mm.

The reinforcing belt part 130 may include a steel cord, and rubber with which the steel cord is topped.

In this case, a diameter of the steel cord is 0.8 mm to 1.0 mm, an elongation percentage of the steel cord is 3.5% or more, and a tensile force of the steel cord is 80 kgf to 110 kgf. To this end, the reinforcing belt part 130 is manufactured by coating the steel cord with topping rubber by inputting the strands of steel cords, one by one, into a spinneret die through a rolling process.

The steel cord has a lower tensile force than a spiral cord in the related art but has an increased EPI, thereby obtaining an effect of inhibiting the growth of the tire and reducing a weight of the tire.

However, in the case of the spiral cord in the related art, a diameter of the steel cord may be 1.1 to 1.5 mm, and a tensile force of the steel cord may be 120 to 170 kg.

In the case of the spiral cord in the related art, a single strand of cord is directly topped with rubber or rubber is attached to and covers the entire cord after the cord is completely wound. In this case, the topping rubber on the single strand of cord is not uniform, and the adhesiveness (tack) between the spiral cord and the topping rubber is degraded, which causes an unsuitable air pressure (defect) when the tire is vulcanized.

In addition, it is difficult to reduce the weight of the spiral cord in the related art because the diameter of the cord is large and the thickness of the topping rubber (including the cord) is 1.5 mm or more.

In contrast, the reinforcing belt part 130 according to the present disclosure may be manufactured such that a thickness of the topping rubber (including the cord) is at least 0.85 mm. Therefore, the reinforcing belt part 130 may be lightweight, thereby reducing rotational resistance against the tire.

The reinforcing belt part 130 may be inserted at different positions according to the present disclosure.

First, the reinforcing belt part 130 may be wound once or twice in the circumferential direction of the tire on outermost peripheral layers of first and third steel belts 121 and 123 or outermost peripheral layers of the second and fourth steel belts 122 and 124.

In this case, the reinforcing belt part 130 is spirally formed and manufactured to have a width of 10 mm to 15 mm.

Second, the reinforcing belt part 130 is inserted between the second steel belt 122 and the third steel belt 123 and wound in the circumferential direction of the tire.

In this case, the reinforcing belt part 130 has the same width as the second steel belt 122.

The process of forming the reinforcing belt part 130 is performed for a working time of 1 minute or less, and the reinforcing belt part 130 is wound with a preset width (10 to 15 mm) while receiving preset tension during the working process. Therefore, the amount of growth of the tire in the circumferential direction is reduced compared to the method in the related art (the method of winding the strands of cords one by one). For example, 5 to 7 minutes are required to wind the single strand of steel cord spirally in the related art.

Third, the reinforcing belt parts 130 are respectively formed at two opposite sides and a central portion of the tread part 110 and disposed to be spaced apart from one another.

Specifically, the reinforcing belt parts 130, which are cut into predetermined widths, are formed on three portions (left, center, and right portions) with a width of 50 to 100 mm between the second steel belt 122 and the third steel belt 123 while receiving the preset tension in the circumferential direction.

In this case, the reinforcing belt parts 130 are positioned at the central portion and the two opposite sides of the tread part 110 when the tread part 110 is viewed in the normal line direction.

Because ground pressures applied to the central portion and the two opposite sides of the tread part 110 are typically different from one another, the reinforcing belt parts 130 are divided and then wound, thereby optimizing the ground contact shapes of the central portion and the two opposite sides of the tread part 110.

In the case of the tire in the related art used for a truck or bus, intervals between the cords are not uniform because the strands of cords made of steel are wound one by one in the form of a spiral coil. Further, the growth of the tire in the circumferential direction of the tire cannot be uniformly inhibited because a high shearing force is generated between the second belt and the third belt.

In contrast, in the case of the reinforcing belt part 130 according to the present disclosure, the steel cord is cut by rolling at preset intervals (EPI (number of cord strands per one inch), which makes it possible to manufacture the reinforcing belt part 130 in which the interval of the steel cord is 14 to 18 EPI.

However, in the case in which the strands of steel cords are wound one by one according to the forming process (SPC) in the related art, the interval between the steel cords is restricted to 9 to 13 EPI, and thus the reinforcing belt part 130 is cut into a width of 10 to 15 mm, such that a small amount of shear stress is generated between the second steel belt 122 and the third steel belt 123.

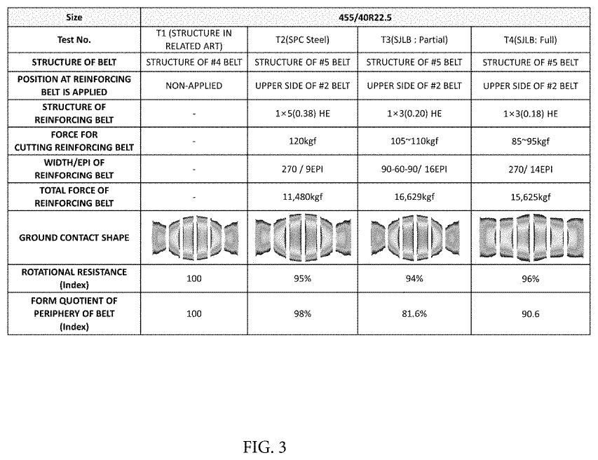

FIG. 3 is a view illustrating a result of analyzing the performance of the heavy-duty tire according to the embodiment of the present disclosure and the performance of a tire having a general structure.

In FIG. 3, T1 represents a tire including four belts having a general structure, T2 represents a tire including five belts including spiral cords, T3 represents a tire (partially) including the reinforcing belt part 130 according to the present disclosure, and T4 represents a tire (fully) including the reinforcing belt part 130 according to the present disclosure.

Specifically, in T1, a structure of a radial tire for a truck or bus in the related art is applied to a tire having an ultra-super single (USS) size. In general, a reinforcing belt is usually applied to the USS tire (T2).

In the case in which the reinforcing belt is applied by winding the strands of cords one by one, there is a limitation in inhibiting the overall growth of the belt casing and the manufacturing time increases.

According to the analysis results illustrated in FIG. 3, T1 is excellent in RR performance, but the five belts, to which the reinforcing belt is applied to optimize the belt durability and the ground contact shape, is generally applied to the USS tire. It can be seen that the RR performance in T1 results from the effect made by reducing the weight.

That is, when in T2 to T4, a weight is set to be equal to a weight in T1, the RR performance is predicted to be equal in level to the RR performance in T1.

According to a result of applying the reinforcing belt (spiral coil (SPC)) of T2, a form quotient of the periphery of the belt decreases by maximum 17% compared to T3 and T4. That is, the durability performance of the reinforcing belt is best in T3 and T4 to which the reinforcing belt part 130 is applied.

When T4 is fully applied, the amount of overall growth of the belt is inhibited to a minimum level, the amount of shearing force between the second belt and the third belt is decreased, and the ground contact shape also becomes quadrangular, such that the ground pressure is uniformly distributed, the tire is uniformly abraded, and the belt performance is improved.

In a case in which a load index is 4,000 Kg/1 EA, the structure including the first to third belts and the reinforcing belt part 130 may be applied to improve the belt durability performance and the RR performance in comparison with the general structure in the related art.

If the load index is high (4,500 kg or more), the reinforcing belt part 130 may be applied by being wound once or twice on an upper side of an outermost periphery of the fourth steel belt 124, which makes it possible to inhibit the amount of growth of the belt, maintain the rigidity of the entire belt even at a high speed, and improve the handling performance.

In the case of T3, the reinforcing belt part 130 is partially (split) applied, which makes it possible to improve the durability of the belt and the RR performance in comparison with the general structure in the related art. However, the reinforcing belt part 130 is partially (split) applied between the second steel belt 122 and the third steel belt 123 (at a position at which the angle of the belt is reversed and the shearing force is maximally generated).

According to the present disclosure described above, since the reinforcing belt part 130 is cut into a preset width (10 to 15 mm), the adhesiveness (tack) between the reinforcing belt part and the belt part is not degraded even though the reinforcing belt part 130 is attached on the outermost peripheral layer of the belt or between the second steel belt 122 and the third steel belt 123. Therefore, an incidence rate of unsuitable air pressure is low.

In addition, according to the present disclosure, in the case in which the slitting is performed on the reinforcing belt part 130 with a width of 10 to 20 mm and the reinforcing belt part 130 is applied by being wound on the upper side of the outermost periphery of the belt, the reinforcing belt part 130 may be applied to the upper sides of the first to third steel belts, the first to fourth steel belts, the second to third steel belts, and the second to fourth steel belts.

According to the present disclosure, since the reinforcing belt part is applied to the upper side of the outermost peripheral layer of the belt, the tire may be uniformly grown under high-speed traveling and high-load conditions, the uniform ground pressure may be ensured, and the handling performance may be improved.

It will be appreciated that the embodiments of the present disclosure have been described above for purposes of illustration, and those skilled in the art may understand that the present disclosure may be easily modified in other specific forms without changing the technical spirit or the essential features of the present disclosure. Therefore, it should be understood that the above-described embodiments are illustrative in all aspects and do not limit the present disclosure. For example, each component described as a single type may be carried out in a distributed manner. Likewise, components described as a distributed type can be carried out in a combined type.

The scope of the present disclosure is represented by the claims to be described below, and it should be interpreted that the meaning and scope of the claims and all the changes or modified forms derived from the equivalent concepts thereto fall within the scope of the present disclosure.

### DESCRIPTION OF REFERENCE NUMERALS

100: Heavy-duty tire
110: Tread part
111: Tread
112: Groove
120: Steel belt part
121: First steel belt
122: Second steel belt
123: Third steel belt
124: Fourth steel belt
130: Reinforcing belt part

What is claimed is:

1. A heavy-duty tire comprising:
a tread part configured to contact with a road surface;
a steel belt part comprising one or more steel belts formed inside the tread part; and
a reinforcing belt part inserted between the one or more steel belts or between the tread part and the steel belt part,
wherein the reinforcing belt part is manufactured as a rolling product made by winding steel cords in a circumferential direction of the tire.

2. The heavy-duty tire of claim 1, wherein the one or more steel belts comprise:
a first steel belt disposed adjacent to a carcass;
a second steel belt positioned above the first steel belt;
a third steel belt positioned above the second steel belt; and
a fourth steel belt positioned above the third steel belt, and
wherein the reinforcing belt part is wound once or twice in the circumferential direction of the tire on outermost peripheral layers of the first and third steel belts or outermost peripheral layers of the second and fourth steel belts.

3. The heavy-duty tire of claim 2, wherein the reinforcing belt part is formed spirally and manufactured to have a width of 10 mm to 15 mm.

4. The heavy-duty tire of claim 1, wherein the one or more steel belts comprise:
a first steel belt disposed adjacent to a carcass;
a second steel belt positioned above the first steel belt;
a third steel belt positioned above the second steel belt; and
a fourth steel belt positioned above the third steel belt, and
wherein the reinforcing belt part is inserted between the second steel belt and the third steel belt and wound in the circumferential direction of the tire.

5. The heavy-duty tire of claim 4, wherein the reinforcing belt part has the same width as the second steel belt.

6. The heavy-duty tire of claim 4, wherein the reinforcing belt parts are respectively formed at two opposite sides and a central portion of the tread part and disposed to be spaced apart from one another.

7. The heavy-duty tire of claim 1, wherein the reinforcing belt part is manufactured by rolling the steel cord within a range of 14 EPI to 18 EPI.

8. The heavy-duty tire of claim 1, wherein the reinforcing belt part is manufactured to have a width of 10 mm to 20 mm.

9. The heavy-duty tire of claim 1, wherein the reinforcing belt part comprises the steel cords and a rubber with which the steel cords are topped, and
wherein a diameter of the steel cords is 0.8 mm to 1.0 mm, and a thickness of the reinforcing belt part is 0.85 mm to 1.1 mm.

10. The heavy-duty tire of claim 1, wherein a tensile force of the steel cords is 80 kgf to 110 kgf.
